(19) United States
(12) Patent Application Publication
(10) Pub. No.: US 2023/0045129 A1
(43) Pub. Date: Feb. 9, 2023

(54) OBJECT DETECTION APPARATUS, SYSTEM, AND METHOD, DATA CONVERSION UNIT, AND NON-TRANSITORY COMPUTER READABLE MEDIUM

(71) Applicant: NEC Corporation, Minato-ku, Tokyo (JP)

(72) Inventors: Nagma Samreen KHAN, Tokyo (JP); Kyota Higa, Tokyo (JP); Kazumine Ogura, Tokyo (JP); Taichi Tanaka, Tokyo (JP); Masayuki Ariyoshi, Tokyo (JP); Tatsuya Sumiya, Tokyo (JP)

(73) Assignee: NEC Corporation, Minato-ku, Tokyo (JP)

(21) Appl. No.: 17/784,230

(22) PCT Filed: Dec. 25, 2019
(86) PCT No.: PCT/JP2019/050976

§ 371 Date: Jun. 10, 2022

(51) Int. Cl. G01S 13/88; G06T 15/00; G06T 7/50; G06V 10/50; G01S 13/89

(52) U.S. Cl. CPC G01S 13/887; G06T 15/00; G06T 7/50; G06V 10/507; G01S 13/89; G06V 2201/07; G06T 2207/10044

(57) ABSTRACT

A receiver receives a radio wave transmitted to a target and scattered by the target to acquire a signal. An imaging unit generates a 3D complex image of the target based on the signal. A value extraction unit extracts intensity information and phase in including an intensity matrix and a phase matrix, the extracted intensity information constituting the intensity matrix and the extracted phases information constituting the phase matrix. A subset selection unit selects a subset from the value set. A transformation unit changes a representation of the subset to generate a 2D real image. A detection unit detects whether there is an undesired object on the target based on the 2D real image.

### TECHNICAL FIELD

The present invention relates to an object detection apparatus, an object detection system, an object detection method, a data conversion unit, and a non-transitory computer readable medium.

### BACKGROUND ART

Various systems to check whether a target person possesses any concealed dangerous object or not have been known. FIG. 14 shows an example of a general radar-based body scanner system 1200 proposed by Non-Patent Literature 1 (NPL 1) for checking whether a target person 1201 possesses any concealed dangerous object or not. In this example, it is assumed that the target person 1201 is present in a screening area (or a fixed area) 1202 in front of a fixed radar antenna put in a side panel 1203. This radar-based body scanner system 1200 measures the target person 1201 that is stationary in the screening area 1202 by the fixed antenna that is a part of a radar system, and receives a measured scattered radar signal through the fixed antenna.

The measured scattered radar signal is used to generate a 3D complex-valued radar image. FIG. 15 schematically shows a basic configuration of the 3D complex radar image CV. As shown in FIG. 15, the 3D complex radar image CV has information about the target person 1201 and the concealed objects on the target person 1201. In FIG. 15, Nx, Ny, and Nz denote dimensions (or the number of points) along the x-axis, y-axis, and z-axis, respectively. The 3D image has both intensity and phase information. The intensity provides information about material of the scattering body and the phase provides information about curvature and distance from the fixed antenna.

This 3D complex-valued radar image is used for detecting whether the target person possesses any dangerous object or not. As for such detection, a system for performing such operation, a general 3D complex data based object detection system is proposed by Non-Patent Literature 2 (NPL 2). This system includes a configuration to decide whether the target person 1201 possesses the dangerous object or not based on the 3D complex radar image CV.

### CITATION LIST

### Non Patent Literature

NPL 1: David M. Sheen, Douglas L. McMakin, and Thomas E. Hall, “Three-Dimensional Millimeter-Wave Imaging for Concealed Weapon Detection”, IEEE Transactions on Microwave Theory and Techniques, vol. 49, No. 9 Sep. 2001.
NPL 2: L. Carrer, “Concealed Weapon Detection: A microwave imaging approach”, Master of Science Thesis, Delft University of Technology, 2012.

### SUMMARY OF INVENTION

### Technical Problem

FIG. 16 is a block diagram schematically showing an object detection system 1100 configured as the radar-based body scanner system. The object detection system 1100 includes a transceiver 1101, an imaging unit 1102, a value extraction unit 1103, an energy projection unit 1104, a transformation unit 1105, and a detection unit 1106. Note that functions of the transceiver 1101 and the imaging unit 1102 are described in NPTL1 and functions of the value extraction unit 1103, the energy projection unit 1004, the transformation unit 1105, and the detection unit 1106 are described in NPTL2.

The transceiver 1101 transmits a radio wave to the target person 1201 through a transmission antenna 1011, and receives the radio waves reflected by the target person 1201 through a reception antenna 1012. The radar transceiver 1101 processes the received signal to generate an intermediate frequency (IF) signal and outputs the IF signal SIG to the imaging unit 1102.

The imaging unit 1102 generates the 3D complex radar image CV of the target person 1201 from the received IF signal SIG. As shown in FIG. 15, the 3D complex radar image CV is the 3D image of the target person 1201.

The value extraction unit 1103 extracts absolute values from the received 3D complex radar image CV to generates a 3D real matrix abs(CV) and outputs the 3D real matrix abs(V) to the energy projection unit 1104.

The energy projection unit 1104 acquires energy-projection EP(x, y) along the z-axis for all pixels in the fixed area 1202 to generate the 2D energy-projection image EP based on the following expression:

$$EP ( x , y ) = {\sum }_{z = 1}^{{N}_{z}} ( abs {( CV ( x , y , z ) )}^{2} , \qquad [ Expression 1 ]$$

$$where$$

$$CV ∈ {C}^{3} . \qquad [ Expression 2 ]$$

The 2D energy-projections image EP can be easily handled by the detection unit 1106 that employs image-based detection algorithms. Further, compared with the 3D complex image CV, since the 2D energy-projections image EP can suppress amount of data, it is possible to reduce processing time and computation resources.

The transformation unit 1105 receives the 2D energy-projections image EP from the energy projection unit 1104. The transformation unit 1105 applies appropriate transformation to transform the 2D energy-projections image EP into a gray-scale image, and outputs the gray-scale image to the detection unit 1106.

The detection unit 1106 uses the received 2D image RV to decide whether the target person 1201 has any concealed dangerous object or not. The decision result DR is displayed by a display unit 1107.

However, the above-mentioned configuration has problems as described below. The first problem is that the value extraction unit 1103 extracts only the absolute values and discards phase data. This leads to loss of information which in turn adversely affects detection accuracy.

The second problem is that values across all the z-dimensions are summed as per the energy projection equation while generating the 2D image from 3D real matrix. Using all the z-dimension without any criteria leads to contaminating the information content with noise, and thereby deteriorates the detection accuracy.

The third problem is the data compression of the above-mentioned configuration is not flexible. In this configuration, it is always necessary to generate the 2D image by highly compressing the 3D complex matrix. Further, the level of compression can be not controlled. In practical applications, the system has some trade-off between accuracy and processing time.

The present invention has been made in view of the above-mentioned problem, and an objective of the present invention is to provide a system capable of accurately and quickly detecting concealed objects.

### Solution to Problem

An aspect of the present invention is an object detection apparatus including: a receiver configured to receive a radio wave transmitted to a target and scattered by the target to acquire a signal; an imaging unit configured to generate a 3D complex image of the target based on the signal; a value extraction unit configured to extract intensity information and phase information for each point of the 3D complex image to generate a value set including the an intensity matrix and a phase matrix, the extracted intensity information constituting the intensity matrix and the extracted phases information constituting the phase matrix; a subset selection block configured to select a subset from the value set; a transformation unit configured to change a representation of the subset to generate a 2D real image; and a detection unit configured to detect whether there is an undesired object on the target based on the 2D real image.

An aspect of the present invention is a data conversion unit including: an imaging unit configured to generate a 3D complex image of a target based on a signal acquired by receiving a radio wave transmitted to a target and scattered by the target; a value extraction unit configured to extract intensity information and phase information for each point of the 3D complex image to generate a value set including the an intensity matrix and a phase matrix, the extracted intensity information constituting the intensity matrix and the extracted phases information constituting the phase matrix; a subset selection block configured to select a subset from the value set; and a transformation unit configured to change a representation of the subset to generate a 2D real image.

An aspect of the present invention is an object detection system including: a transmission antenna; a reception antenna; a transmitter configured to transmit a radio wave to the target through the transmission antenna; a receiver configured to receive the radio wave scattered by the target through the reception antenna to acquire a signal; an imaging unit configured to generate a 3D complex image of a target based on the signal; a value extraction unit configured to extract intensity information and phase information for each point of the 3D complex image to generate a value set including the an intensity matrix and a phase matrix, the extracted intensity information constituting the intensity matrix and the extracted phases information constituting the phase matrix; a subset selection block configured to select a subset from the value set; transformation unit configured to change a representation of the subset to generate a 2D real image; and a detection unit configured to detect whether there is an undesired object on the target based on the 2D real image and outputs the detection result; and a display unit configured to display the detection result.

An aspect of the present invention is an object detection method including: receiving a radio wave transmitted to a target and scattered by the target to acquire a signal; generating a 3D complex image of a target based on the signal; extracting intensity information and phase information for each point of the 3D complex image to generate a value set including the an intensity matrix and a phase matrix, the extracted intensity information constituting the intensity matrix and the extracted phases information constituting the phase matrix; selecting a subset from the value set; changing a representation of the subset to generate a 2D real image; and detecting whether there is an undesired object on the target based on the 2D real image.

An aspect of the present invention is a non-transitory computer readable medium storing a program that causes a computer to execute processes of: receiving a radio wave transmitted to a target and scattered by the target to acquire a signal; generating a 3D complex image of a target based on the signal; extracting intensity information and phase information for each point of the 3D complex image to generate a value set including the an intensity matrix and a phase matrix, the extracted intensity information constituting the intensity matrix and the extracted phases information constituting the phase matrix; selecting a subset from the value set; changing a representation of the subset to generate a 2D real image; and detecting whether there is an undesired object on the target based on the 2D real image.

### Advantageous Effects of Invention

According to the present invention, it is possible to provide a system capable of accurately and quickly detecting concealed objects.

### BRIEF DESCRIPTION OF DRAWINGS

FIG. 1 is a block diagram schematically showing a configuration of an object detection system in which an object detection apparatus according to a first example embodiment is implemented;

FIG. 2 is a block diagram schematically showing a configuration of the object detection apparatus according to the first example embodiment;

FIG. 3 shows a configuration of a data conversion unit;

FIG. 4 is a flowchart schematically showing an operation of the object detection apparatus according to the first example embodiment;

FIG. 5 is a block diagram showing an alternative configuration of the object detection apparatus 100 according to the first example embodiment;

FIG. 6 is a block diagram schematically showing configuration of an object detection apparatus according to a second example embodiment;

FIG. 7 is a flowchart schematically showing an operation of the object detection apparatus according to the second example embodiment;

FIG. 8 schematically shows the 3D complex radar image and example three points;

FIG. 9 shows examples of the depth matrix, the intensity matrix, and the phase matrix;

FIG. 10 is a block diagram schematically showing a configuration of an object detection apparatus 100 according to a third example embodiment;

FIG. 11 is a flowchart showing an operation of the object detection apparatus according to the third example embodiment;

FIG. 12 schematically illustrates an example configuration of a system configuration including a server and a computer;

FIG. 13 schematically illustrates an example configuration of the computer;

FIG. 14 shows an example of a general radar-based body scanner system;

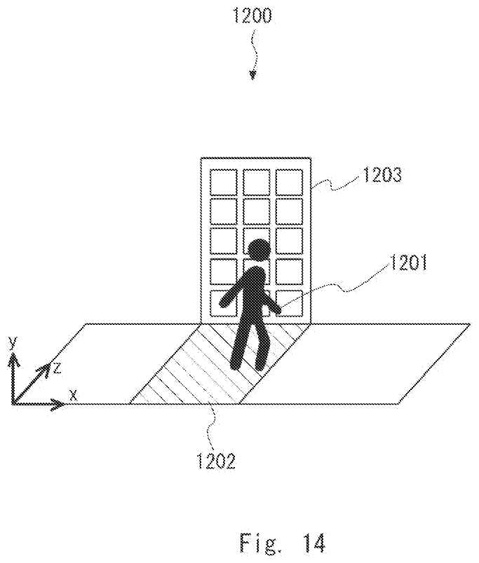

FIG. 15 schematically shows a basic configuration of a 3D complex radar image; and

FIG. 16 is a block diagram schematically showing an object detection system.

### DESCRIPTION OF EMBODIMENTS

Example embodiments of the present invention will be described below with reference to the drawings. In the drawings, the same elements are denoted by the same reference numerals, and thus a repeated description is omitted as needed.

### First Example Embodiment

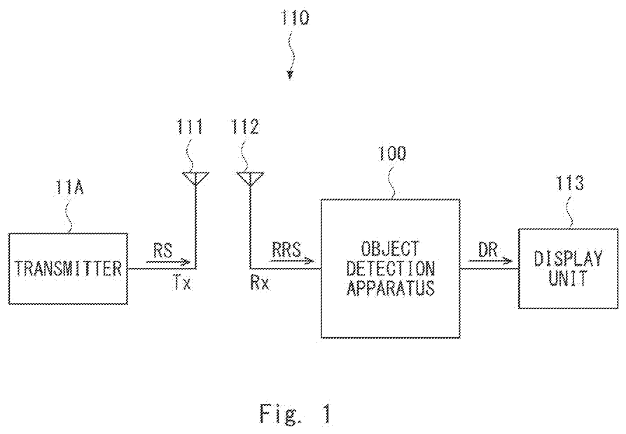

An object detection apparatus 100 according to a first example embodiment will be described. The object detection apparatus 100 is implemented in an object detection system 110 for detecting a concealed object on a target person based on a 3D complex data. FIG. 1 is a block diagram schematically showing a configuration of the object detection system 110 in which the object detection apparatus 100 according to the first example embodiment is implemented. The object detection system 110 includes a transmitter 11A, the object detection apparatus 100, a transmission antenna 111, a reception antenna 112, and a display unit 113.

The transmitter 11A transmits a radar signal RS to the transmission antenna 111 and then the transmission antenna 111 radiates a radio wave that is the radar signal RS to the target person. The object detection apparatus 100 is configured to receive the radio wave reflected and/or scattered by the target person through the reception antenna 112 as a received radar signal RRS. The object detection apparatus 100 detects the concealed object on the target person using the received radar signal RRS and outputs the detection result DR to the display unit 113.

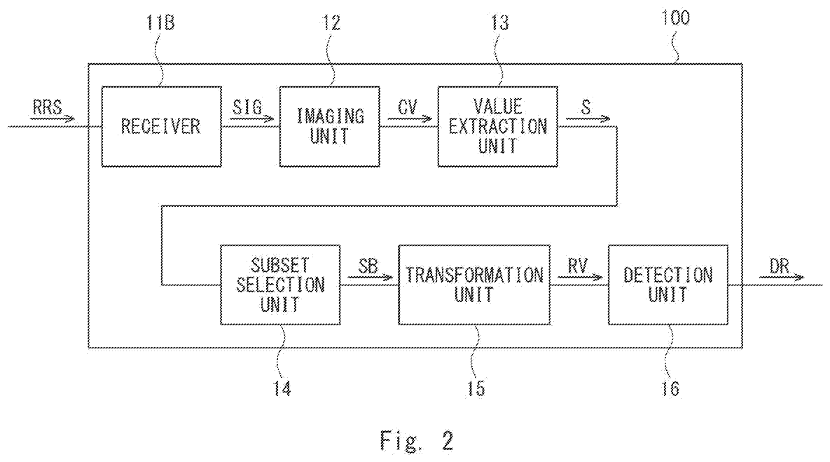

Subsequently, a configuration of the object detection apparatus 100 will be described. FIG. 2 is a block diagram schematically showing the configuration of the object detection apparatus 100 according to the first example embodiment. The object detection apparatus 100 includes a receiver 11B, an imaging unit 12, a value extraction unit 13, a subset selection unit 14, a transformation unit 15, and a detection unit 16. The receiver 11B, the imaging unit 12, the value extraction unit 13, the transformation unit 15, and the detection unit 16 are similar to the reception function of the transceiver 1101, the imaging unit 1102, the value extraction unit 1103, the transformation unit 1105, and the detection unit 1106 described above, respectively.

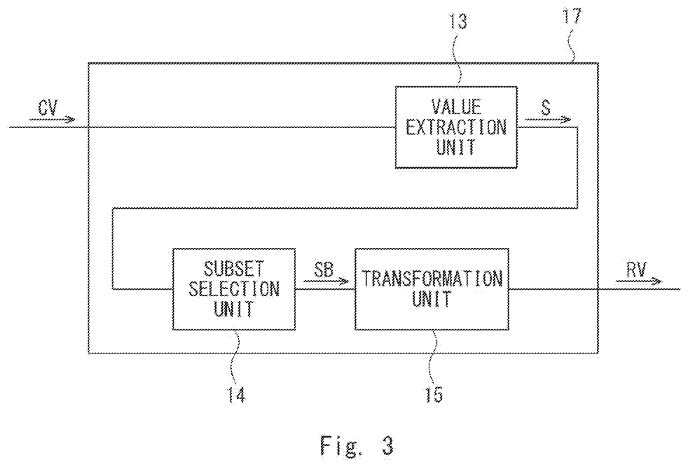

In this configuration, the value extraction unit 13, the subset selection unit 14, and the transformation unit 15 constitutes the data conversion unit 17 to perform the necessary processing between the imaging and the detection in the object detection apparatus 100. FIG. 3 shows a configuration of the data conversion unit 17.

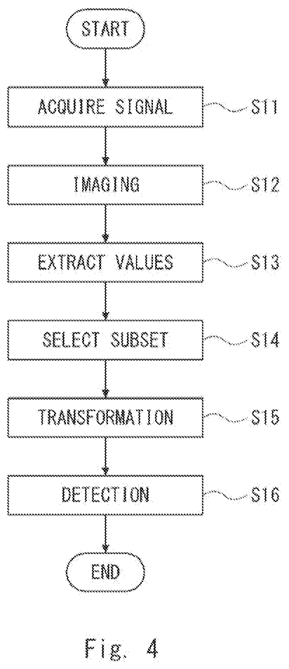

Hereinafter, a configuration of each component and an operation of the object detection apparatus 100 will be described in detail with reference to FIGS. 2 to 4. FIG. 4 is a flowchart schematically showing the operation of the object detection apparatus 100 according to the first example embodiment.

### Step S11

The transmitter 11A transmits the radar signal RS to the transmission antenna 111 and the receiver 11B receives the received radar signal RRS. The receiver 11B processes the received radar signal RRS to generate an intermediate frequency (IF) signal SIG and output the IF signal SIG to the imaging unit 12.

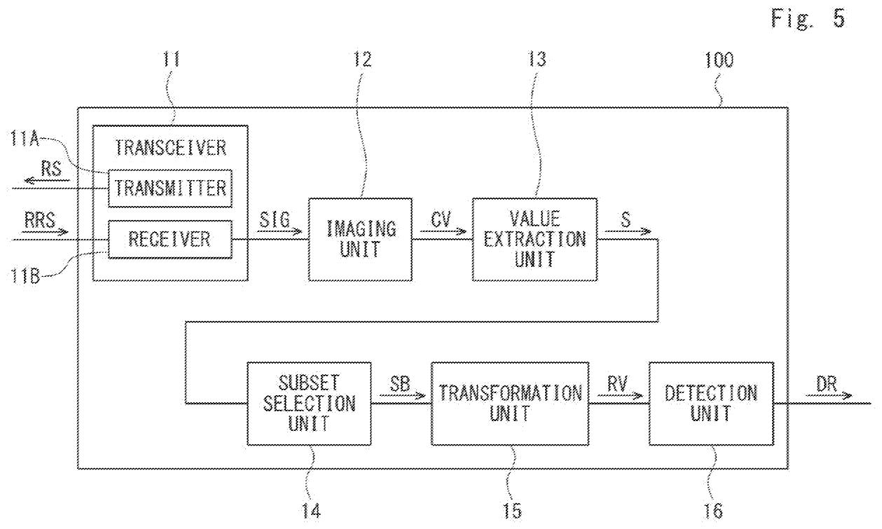

Although the transmitter 11A is disposed separately from the object detection apparatus 100 in FIGS. 1 and 2, however, the transmitter 11A and the receiver 11B may constitute a single transceiver 11 and the transceiver 11 may be disposed in the object detection apparatus 100. FIG. 5 is a block diagram showing an alternative configuration of the object detection apparatus 100 according to the first example embodiment. As shown in FIG. 5, the transceiver 11 includes the transmitter 11A transmitting the radar signal RS and the receiver 11B receiving the received radar signal RRS.

### Step S12

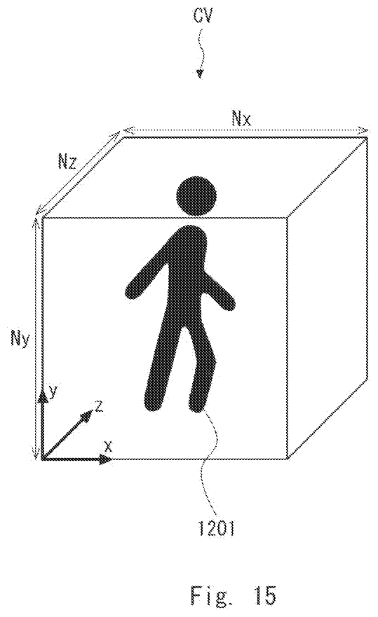

The imaging unit 12 generates the 3D complex radar image CV of the target person from the received IF signal SIG by using various imaging techniques such as beamforming and MIMO RMA (multi-input-multi-output range migration algorithm). As shown in FIG. 15, the 3D complex radar image CV is a 3D image of the target person.

### Step S13

The value extraction unit 13 extracts phase and intensity values for each point represented by a complex value from the 3D complex radar image CV to generate a phase matrix P and an intensity matrix I whose elements are the members of the real value space R³ as expressed by the following expressions:

### Expression 3

P∈R³

I∈R³

The phase matrix P and the intensity matrix I constitute a value set S={P, I}. In an alternative example, the value extraction unit 13 can also extract real values and imaginary values for each point instead of the phase matrix P and the intensity matrix I in order to calculate the intensity values and the phase values according to well-known knowledge.

### Step S14

The subset selection unit 14 selects a subset SB={P, S_I} from the value set S={P, I}, where S_I is the subset of the difference set between the values set S and the phase matrix P as expressed by the following expressions:

S_ICS\P. [Expression 4]

Note that the phase matrix P is always selected in this case. The selection is controlled by a detection technique employed in the detection unit 16 and also by desired accuracy for the object detection system 110.

### Step S15

The transformation unit 15 receives the subset SB and changes the representation thereof and/or rescales the elements thereof to a suitable format by using the information included in the selected matrices, i.e. phase (and/or intensity) in order to generate a transformed real image matrix RV whose elements are the members of the real value space R³ as expressed by the following expressions:

RV∈R³ [Expression 5]

The transformation technique employed in the transformation unit 15 depends on the subset SB, the model being used in the detection unit 16, and the desired accuracy of the detection. The transformation unit 15 generates and outputs a real image matrix RV.

Some of the example transformation technique include encoding phase information, constant value of 1, and intensity information in the H (Hue), S (Saturation) and V (Value) channels for every index along the z-axis of the 3D phase and intensity matrices included in the subset SB. Note that 1 is set to S (Saturation) in this case, and however, any value except for zero may be set to S (Saturation). Note that the HSV image may be optionally converted to an RGB image. Another example transformation technique is rescaling the value between 0-255 or converting a data format to unsigned integer. The transformation unit 15 may perform one or more transformation such as encoding the image (HSV, RGB) and rescaling. The transformed real image matrix RV is output to the detection unit 16.

### Step S16

The detection unit 16 receives and analyzes the real value matrix RV for detecting the concealed objects. The detection result DR includes information indicating the presence of the concealed objects when concealed object is detected. The detection unit 16 performs various detection models such as statistical analysis, machine learning, deep learning, and a combination of all or a part of those. It should be appreciated that the real image matrix RV may be designed appropriately by the transformation unit 15 depending on the technique employed for the detection.

The detection result DR is displayed by a display unit 113. Although the display unit 113 is disposed outside of the object detection apparatus 100, the display unit 113 may be disposed in the object detection apparatus 100. Accordingly, the display unit 113 can indicate whether the target person is safe or not.

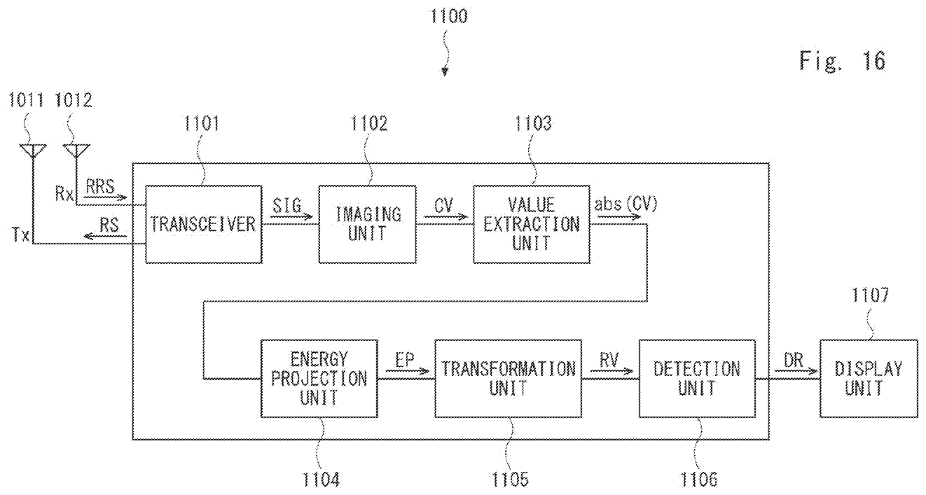

As described above, according to the present configuration, the object detection apparatus 100 can use the phase information and is flexible enough to select the suitable information from the 3D complex radar image (either only phase or both phase and intensity) based on requirement. Therefore, it can be understood that the detection accuracy of the object detection apparatus 100 can be improved compared to the object detection apparatus 1100 described with reference to FIG. 16.

### Second Example Embodiment

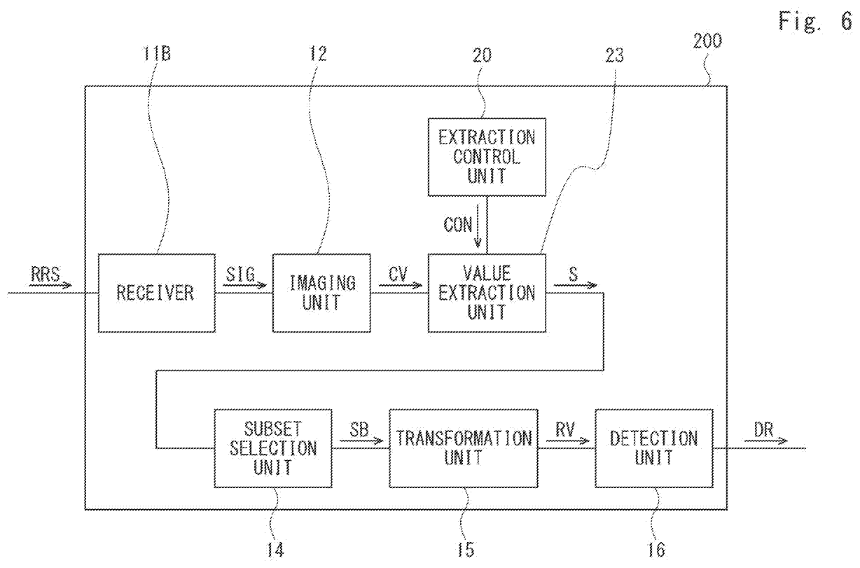

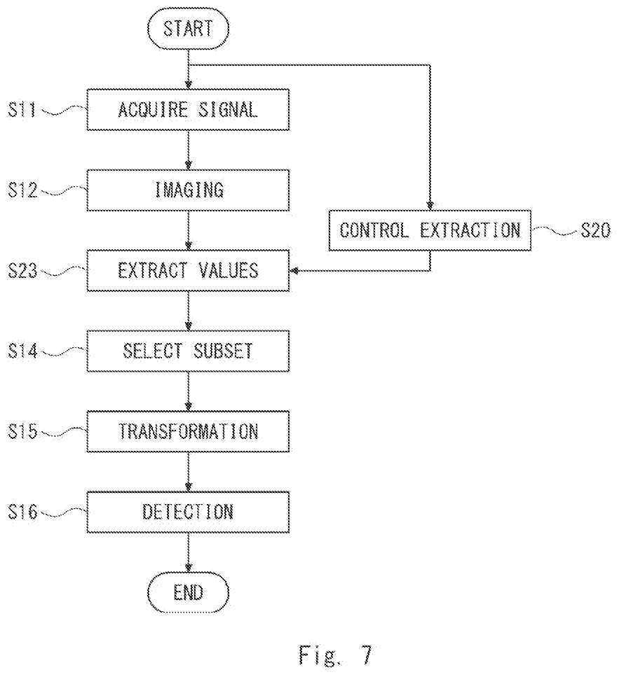

A configuration and an operation of an object detection apparatus 200 according to a second example embodiment will be described with reference to FIGS. 6 and 7. FIG. 6 is a block diagram schematically showing configuration of the object detection apparatus 200 according to the second example embodiment according to the second example embodiment. FIG. 7 is a flowchart schematically showing the operation of the object detection apparatus 200. The object detection apparatus 200 has a configuration in which the value extraction unit 13 in the object detection apparatus 100 is replaced with a value extraction unit 23 and an extraction control unit 20 is added to the object detection apparatus 100 according to the first example embodiment. Since the receiver 11B, the imaging unit 12, the subset selection unit 14, the transformation unit 15, and the detection unit 16 are the same as those of the object detection apparatus 100, the descriptions thereof will be omitted.

### Steps S11, S12

Since the steps S11 and S12 in FIG. 7 are the same as those in FIG. 4, the descriptions thereof will be omitted.

Steps S20 The extraction control unit 20 can reduce the processing time of the object detection system 110 and make it more real time while guaranteeing to extract enough relevant information for achieving the desired detection accuracy. Especially, the extraction control unit 20 controls the value extraction unit 23 to compress the output information.

The extraction control unit 20 decides how to select one or more points over selected axis of compression. In this example, it is assumed that the z-axis (or the depth-axis, in this case) to be the axis of compression. For achieving the compression, the extraction control unit 20 decides one or more functions fᵢ:CV→Dᵢ that are applied to the value extraction unit 23 to extract a desired and compressed information that are one or more depth index matrices D from the 3D complex radar image CV. The selected function further has to make sure that valid phase information can be extracted for the selected points.

The depth index matrices D is defined in the 2D real number space as expressed by the following expression:

Dᵢ∈R³ [Expression 6]

The depth index matrices Dᵢ includes the z-index of the selected point along the z-axis in the 3D complex radar image CV that will be used for the detection. Note that, in contrast to this, in the case in the first example embodiment, all the points of the 3D complex radar image CV along the z-axis are used. Since it is possible to reduce the number of the points relevant to the calculation compared with that of the first example embodiment, the processing time can be definitely reduced.

The selection and functions fᵢ are controlled by a policy selected by the object detection system 110. The policy depends on the detection technique being employed, the reduction in processing time and the desired accuracy. As mentioned above, the extraction control unit 20 outputs the functions fᵢ to the value extraction unit 23. When accuracy requirements are high, the functions may be defined to select two or more points along the z-axis.

### Steps S23

For example, in the case of selecting two points along the z-axis, the z-index whose value is the maximum in the z-axis (i.e. an element of argmax) and the z-index whose value is the second largest value in the z-axis (i.e. an element of arg2ndmax) may be selected. In this case, two sets of the depth matrix, the phase matrix and the intensity matrix, one for the argmax information and the other for the arg2ndmax information, are generated. Thus, two images corresponding to the argmax information and the arg2ndmax are generated in the transformation unit 15 and these two images are provided to the detection unit 16. The detection unit 16 processes the two images separately from each other and combines the processing results thereof to output the detection result. Note that the two images may be combined into multiple channels of a single input image and the single input image may be provided to the detection unit 16. In this case, the detection unit 16 may process the single input image and output the processing results as in the case where the detection unit 16 receives and processes the two images as described above.

Although the selection scheme, the argmax and the arg2ndmax have been described in the above, other scheme may be adopted. As examples of functions, arg-thresh-abs-max, surface-check, and constant scheme will be described. In the arg-thresh-abs-max, values less than a threshold TH1 in the 3D complex radar image CV are set to 0, and the points are selected as in the case of the argmax. By applying the arg-thresh-abs-max, the effect of the noise components whose intensities are fluctuated and relatively small can be eliminated. In the surface-check, the first point along the z-axis (from the minimum z-index or the maximum z-index) which has a value greater than a threshold TH2 is selected. The constant scheme is the simplest example of the selection scheme. In this scheme, the points of the constant depth (e.g. the z-index is 2.) for all (x,y) points irrespective of the value thereof in the 3D complex radar image CV are selected. Thus, a single depth slice of the constant z-index is extracted from the 3D complex radar image CV. Note that the valid phase values exist for the z-depth points selected by these example functions.

Hereinafter, for simplicity, an example case of a single function using the argmax will be described, and hence the suffix i will be dropped from the function f and the depth index matrix D.

As described in the first example embodiment, the value extraction unit 23 receives the 3D complex radar image CV from the imaging unit 12. Unlike in the first example embodiment, the value extraction unit 23 does not extracts the phase and intensity matrices for all points the 3D complex radar image CV but extracts only the selected points from the 3D complex radar image CV.

The set of points are specified by the depth index matrix D and the value extraction unit 23 selects the points using the function f:−>D provided by the extraction control unit 20. The phase matrix P and the intensity matrix I are 2D matrices and given by:

P=angle(CV(x,y,D(x,y)),∈R²,

I=absolute(CV(x,y,D(x,y))∈R². [Expression 7]

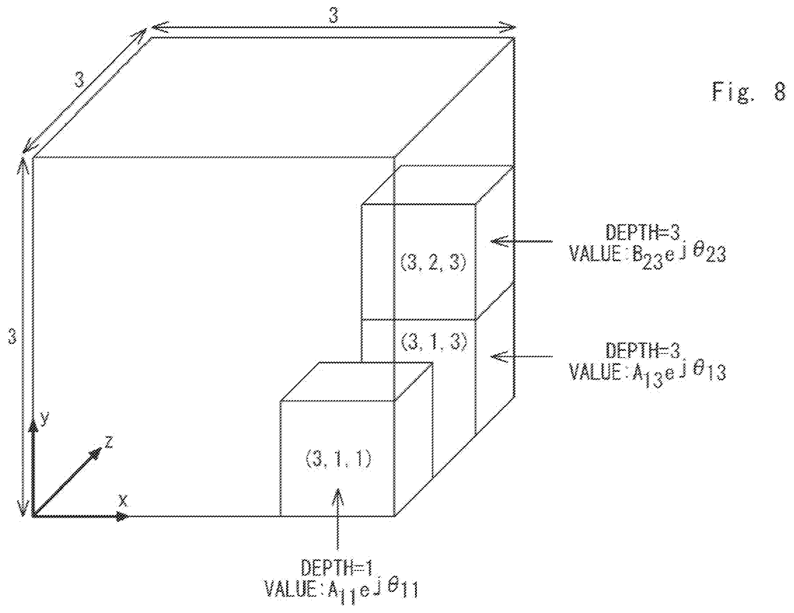

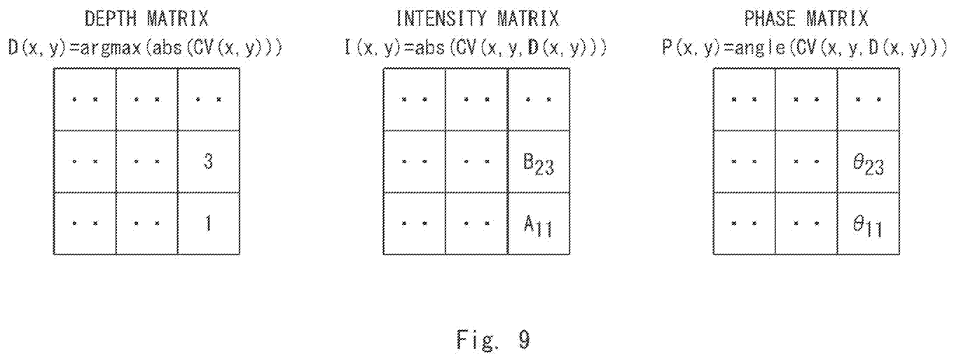

Here, the extraction performed by the value extraction unit 23 will be described with reference to FIG. 8. FIG. 8 schematically shows the 3D complex radar image CV and example three points. FIG. 9 shows examples of the depth matrix D, the intensity matrix I, and the phase matrix P. The extraction control unit 20 provides the value extraction unit 23 with a control signal CON to set the function f for selecting the depth (point) thereto. In this example, the function f is given by the following expression:

f=argmax(abs(V(x,y))). [Expression 8]

In FIG. 8, three example (x, y) points are indicated in the 3D complex radar image CV having three dimensions along x, y and z axis. Each of these points is represented by the intensity and the phase both as they are complex. Likewise, the depth index matrix D, the phase matrix P and the intensity matrix I are the 2D matrices having the dimension of 3×3 as shown in FIG. 9. The value of the depth index matrix D at the position (x, y) is D(x, y) and indicates the z-index of the points having the maximum intensity value for that (x, y) position. In this example, since the point (3, 1, 1) has the maximum intensity value among all three points along the z-axis and thus the value D(3, 1) is 1. After calculating the depth index matrix D, the phase matrix P and the intensity matrix I can be found by calculating values of the phase and the intensity at each (x, y) for the point(x, y, D(x, y)) as described above.

The value extraction unit 23 outputs the value set S={I,P,D} similarly to the first example embodiment. However, in this case, the values set S further includes the depth index matrix D. The matrix D is retained to carry forward the z-axis information and will be further used to compensate for information lost while converting the 3D phase and intensity matrices to the 2D matrices. In an alternative implementation, the absolute value extraction unit 23 can also extract the real and imaginary value 2D matrices for the selected points instead of the phase matrix P and the intensity matrix I as mentioned in the first example embodiment.

### Step S14 to S16

Since the steps S14 to S16 in FIG. 7 are the same as those in FIG. 4, the descriptions thereof will be omitted. Note that, in this case, the real image matrix RV output from the transformation unit 15 has much fewer dimensions along the z-axis compared to the 3D complex radar image CV, because of the fact that the matrices in the received subset SB are in R².

As for transformation techniques, some examples are further described. Here, the examples other than those described in the first example embodiment will be described. One of the other techniques is to encode phase information, constant value of 1 and depth information in the H, S and V channels, respectively. Another approach is to encoding phase information, depth information and intensity information in the H, S and V channel respectively. This HSV data can optionally have one or more transformations further applied like converting to RGB image, rescaling between 0-255, converting to unsigned integer. In some cases, the phase information, constant value of 1, and intensity information is encoded in the H, S and V channels respectively. The RGB image generated from the HSV image using operations described above also may have an additional depth channel attached to generate the RGBD (RBG+Depth) image. The depth channel is also likewise rescaled and reformatted before attaching to the RGB channels.

In this configuration, the detection technique, the desired accuracy, and processing time can be decided beforehand further based on the policy of the extraction control unit 20 serving as the dependable components.

As described above, the object detection apparatus 200 according to the second example embodiment selects the z-index of the 3D complex radar image CV. This is unlike the object detection apparatus 100 in which the 2D image is generated by summing across all the z-indices (dimensions) in the 3D complex radar image CV, where the noise is summed along with information thus corrupting the information content. In contrast to this, the object detection apparatus 200 can achieve the compression along z-dimension while making sure that it selects the suitable z-index by using the f:CV->D in decide points.

Further, according to the object detection apparatus 200, another defect of the object detection apparatus 100 that is contamination of information with noise can be solved. Using the compressed real image RV as described above leads to an increase in detection accuracy and also this performance can be achieved in real time.

Note that only the single depth matrix D is considered in the above description In the above description, and, however, it should be appreciated that, in the case of multiple depth matrices {D_i}, there may be multiple phase matrices {P_i} and intensity matrice {I_i} as appropriate.

### Third Example Embodiment

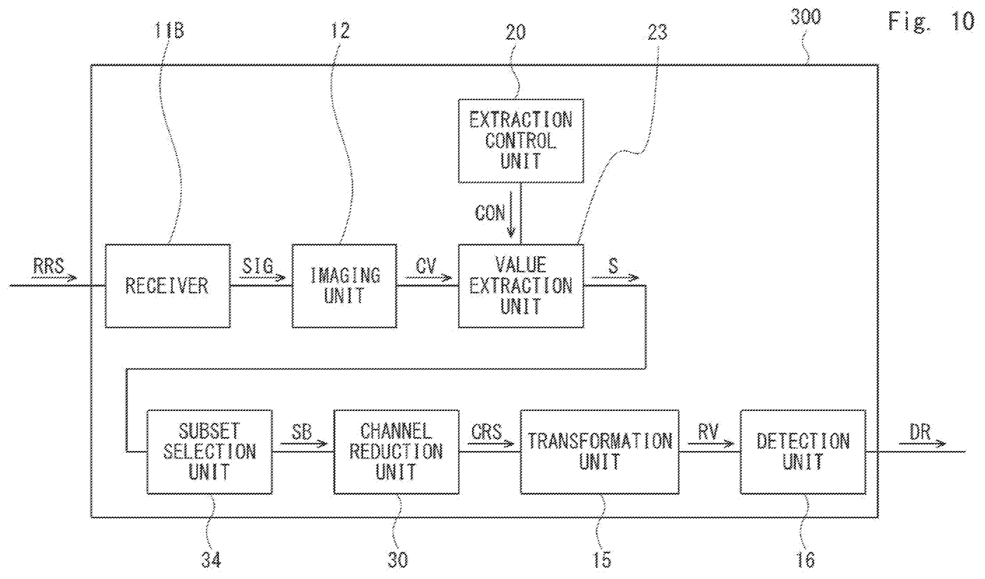

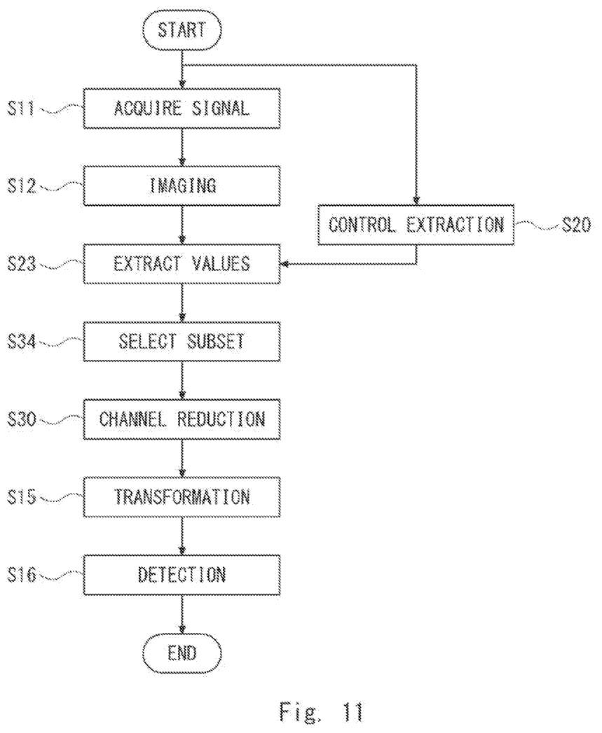

A configuration and an operation of an object detection apparatus 300 according to a third example embodiment will be described with reference to FIGS. 10 and 11. FIG. 10 is a block diagram schematically showing a configuration of the object detection apparatus 300 according to the third example embodiment. FIG. 11 is a flowchart showing an operation of the object detection apparatus 300 according to the third example embodiment. The object detection apparatus 300 has a configuration in which the subset selection unit 14 in the object detection apparatus 200 is replaced with a subset selection unit 34 and a channel reduction unit 30 is added to the object detection apparatus 200.

### Steps S11, S12, S23, S15, S16

Since the steps S11, S12, S23, S15, S16 in FIG. 11 are the same as those in FIG. 7, the description of those will be omitted.

In the present example embodiment, the channel reduction unit 30 performs post-processing on the subset SB to further refine the information content.

Further, compared to the second embodiment, the subset selection unit 34 may operate in a different manner. The steps S30 and S34 will be described in detail.

### Step S34

The subset selection unit 34 receives the value set S={I,P,D} generated by the value extraction unit and outputs the subset SB as in the case of subset selection unit 34 according to the second example embodiment. In the third example embodiment, the subset selection unit 34 always selects the phase matrix P and selects at least one of the depth matrix D and the intensity matrix I to generate the subset SB. Thus, in the third example embodiment, the cardinality of the subset SB is at least 2.

### Step S30

The channel reduction unit 30 receives the subset SB from the subset selection unit 34 and outputs a matrix whose z-dimension is less than the cardinality of the value subset SB. That is, z-dimension is equal to or more than one. Here, the phase, intensity, and depth matrices are treated as different channels of the image, as they include different types of information for the same image. The subset selection unit 34 uses the information from the phase matrix and either or both of the depth matrix D and the intensity matrix I, outputs the reduced number of matrices compared to the input matrices, and thereby the channel reduction can be achieved.

In the present example embodiment, the information included in one or more matrices is processed using the information included in the other input matrix/matrices, and the processed channel(s) which are reduced compared to the input channels is output. Hereinafter, an example in which the channel reduction unit 30 uses the intensity matrix I to process values in the depth matrix D and the phase matrix P. The detail of the processing will be described below.

The subset selection unit 34 receives the value set S={I, P, D} from the value extraction unit 13. The subset selection unit 34 selects all the three matrices I, P, and D in the value set S as the subset SB (i.e. SB=S) and outputs the subset SB to the channel reduction unit 30. After the receiving the subset SB={I,P,D}, the channel reduction unit 30 uses the intensity matrix I to covert some values in the depth matrix D and the phase matrix P to 0. In this example, the (x, y) positions of the phase matrix P and the depth matrix D for which the intensity value I(x, y) is greater than a threshold value TH are retained as it is, and otherwise the (x, y) positions thereof are replaced with zero. This processing is represented by the following expressions:

$$P ( x , y ) = \{ \begin{matrix}P ( x , y ) , & if I ( x , y ) \geq T H \\ 0 , & otherwise\end{matrix} \begin{matrix} \\ \end{matrix} , \qquad [ Expression 9 ]$$

$$D ( x , y ) = \{ \begin{matrix}D ( x , y ) , & if I ( x , y ) \geq TH \\ 0 , & otherwise\end{matrix} .$$

That is, the values being noise and/or not significantly effecting can be eliminated by this processing.

The refined phase and depth matrices are then passed on to the transformation unit 15. These reduced channel(s) are processed by the transformation unit 15 similar to that of the second example embodiment to generate the real and compressed image RV. The presence of the channel reduction unit 30 refines the information content and further reduces the dimension of the output image RV.

In this configuration, the detection technique, the desired accuracy, and processing time can be decided beforehand further based on the policy of the channel reduction unit 30 and the subset selection unit 34 serving as the dependable components compared to the object detection apparatus 200.

As described, the object detection apparatus 300 according to the third example embodiment further refines the information content in the phase, depth and intensity channels and further reduces the information content thereof. Therefore, the implementation of the channel reduction unit 30 makes it possible to further reduce the contamination of useful information by noise. It is possible to further improve the detection accuracy in real time by using the compressed real image RV with the refined information content.

### Other Example Embodiments

Note that the present invention is not limited to the above example embodiments and can be modified as appropriate without departing from the scope of the invention. For example, in the above example embodiments, the present invention is described as a hardware configuration, but the operations of the object detection apparatus, that is, the receiver the transceiver, the imaging unit, the value extraction unit, the subset selection units, the transformation unit, the detection unit, the extraction control unit, and the channel reduction unit by causing a CPU (Central Processing Unit) to execute a computer program. The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line, such as electric wires and optical fibers, or a wireless communication line.

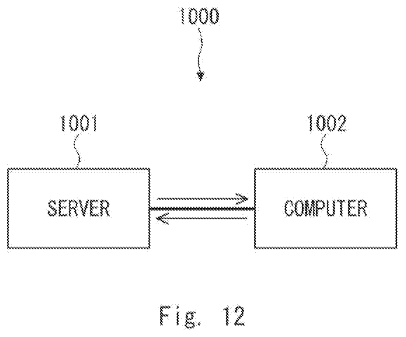

An example in which the distributed storage control system 100 is configured by a server and a computer will be described. FIG. 12 schematically illustrates an example configuration of a system configuration 1000 including a server 1001 and a computer 1002. The computer 1002 executes a program to perform the operations of the object detection apparatus, that is, the receiver, the transceiver, the imaging unit, the value extraction unit, the subset selection units, the transformation unit, the detection unit, the extraction control unit, and the channel reduction unit.

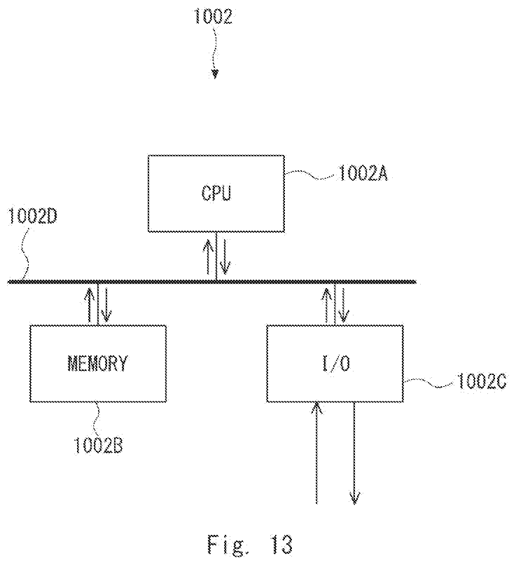

FIG. 13 schematically illustrates an example configuration of the computer 1002. The computer 1002 includes a CPU 1002A, a memory 1002B, an input/output interface (I/O) 1002C and a bus 1002D. The CPU 1002A, the memory 1002B and the input/output interface (I/O) 1002C can communicate each other through the bus 1002D. The CPU 1002A achieves functions of the object detection apparatus, that is, the receiver, the transceiver, the imaging unit, the value extraction unit, the subset selection units, the transformation unit, the detection unit, the extraction control unit, and the channel reduction unit by executing the program. The memory 1002B may store the program. The computer 1002 may communicate with the sever 1001 through the I/O 1002C. The server 1001 may also have a similar configuration to the computer 1002.

Further, the single computer having the similar configuration to the computer 1002 may function as the object detection apparatus, that is, the receiver, the transceiver, the imaging unit, the value extraction unit, the subset selection units, the transformation unit, the detection unit, the extraction control unit, and the channel reduction unit by executing the program.

While the present invention has been described above with reference to example embodiments, the present invention is not limited to the above example embodiments. The configuration and details of the present invention can be modified in various ways which can be understood by those skilled in the art within the scope of the invention.

While the present invention has been described above with reference to exemplary embodiments, the present invention is not limited to the above exemplary embodiments. The configuration and details of the present invention can be modified in various ways which can be understood by those skilled in the art within the scope of the invention.

While the present invention has been described above with reference to exemplary embodiments, the present invention is not limited to the exemplary embodiments stated above.

(Supplementary Note 1) An object detection apparatus including: a receiver configured to receive a radio wave transmitted to a target and scattered by the target to acquire a signal; an imaging unit configured to generate a 3D complex image of the target based on the signal; a value extraction unit configured to extract intensity information and phase information for each point of the 3D complex image to generate a value set including the an intensity matrix and a phase matrix, the extracted intensity information constituting the intensity matrix and the extracted phases information constituting the phase matrix; a subset selection block configured to select a subset from the value set; a transformation unit configured to change a representation of the subset to generate a 2D real image; and a detection unit configured to detect whether there is an undesired object on the target based on the 2D real image.

(Supplementary Note 2) The object detection apparatus according to Supplementary Note 1, in which the value extraction unit extracts an intensity value and a phase value for each point of the 3D complex image; or the value extraction unit extracts a real value and an imaginary value for each point of the 3D complex image to calculate the intensity value and the phase value.

(Supplementary Note 3) The object detection apparatus according to Supplementary Note 1 or 2, further including an extraction control unit configured to the control the value extraction unit to extract the phase matrix and the intensity matrix each dimension of which is reduced compared to the 3D complex image.

(Supplementary Note 4) The object detection apparatus according to Supplementary Note 3, in which the extraction control unit controls the value extraction unit to extract a part of the intensity information and the phase information of the 3D complex image.

(Supplementary Note 5) The object detection apparatus according to Supplementary Note 4, in which the value extraction unit selects one or more depth of the 3D complex image whose intensity information and phase information to be extracted, and extracts the intensity information and the phase information from the selected depth of the 3D complex image.

(Supplementary Note 6) The object detection apparatus according to Supplementary Note 5, in which the value extraction unit generates a depth matrix indicating the points to be selected and adds the depth matrix into the value set.

(Supplementary Note 7) The object detection apparatus according to Supplementary Note 6, further including a channel reduction unit reduces the content of the subset.

(Supplementary Note 8) The object detection apparatus according to Supplementary Note 7, in which, when one of the phase information and the intensity information of each point is less than a predetermined value, the channel reduction unit replace the depth value, and the other of the phase information and the intensity information of each point.

(Supplementary Note 9) The object detection apparatus according to Supplementary Note 8, in which the predetermined value is zero.

(Supplementary Note 10) The object detection apparatus according to any one of Supplementary Notes 1 to 9, further including a transmitter configured to transmit the radio wave to the target.

(Supplementary Note 11) A data conversion unit including: a value extraction unit configured to extract intensity information and phase information for each point of a 3D complex image to generate a value set including the an intensity matrix and a phase matrix, the 3D complex image being based on a signal acquired by receiving a radio wave transmitted to a target and scattered by the target, the extracted intensity information constituting the intensity matrix and the extracted phases information constituting the phase matrix; a subset selection block configured to select a subset from the value set; and a transformation unit configured to change a representation of the subset to generate a 2D real image.

(Supplementary Note 12) An object detection system including: a transmission antenna; a reception antenna; a transmitter configured to transmit a radio wave to the target through the transmission antenna; a receiver configured to receive the radio wave scattered by the target through the reception antenna to acquire a signal; an imaging unit configured to generate a 3D complex image of a target based on the signal; a value extraction unit configured to extract intensity information and phase information for each point of the 3D complex image to generate a value set including the an intensity matrix and a phase matrix, the extracted intensity information constituting the intensity matrix and the extracted phases information constituting the phase matrix; a subset selection block configured to select a subset from the value set; a transformation unit configured to change a representation of the subset to generate a 2D real image; a detection unit configured to detect whether there is an undesired object on the target based on the 2D real image and outputs the detection result; and a display unit configured to display the detection result.

(Supplementary Note 13) An object detection method including: receiving a radio wave transmitted to a target and scattered by the target to acquire a signal;

generating a 3D complex image of a target based on the signal; extracting intensity information and phase information for each point of the 3D complex image to generate a value set including the an intensity matrix and a phase matrix, the extracted intensity information constituting the intensity matrix and the extracted phases information constituting the phase matrix; selecting a subset from the value set; changing a representation of the subset to generate a 2D real image; and detecting whether there is an undesired object on the target based on the 2D real image.

(Supplementary Note 14) A non-transitory computer readable medium storing a program that causes a computer to execute processes of: receiving a radio wave transmitted to a target and scattered by the target to acquire a signal; generating a 3D complex image of a target based on the signal; extracting intensity information and phase information for each point of the 3D complex image to generate a value set including the an intensity matrix and a phase matrix, the extracted intensity information constituting the intensity matrix and the extracted phases information constituting the phase matrix; selecting a subset from the value set; changing a representation of the subset to generate a 2D real image; and detecting whether there is an undesired object on the target based on the 2D real image.

### REFERENCE SIGNS LIST

11 TRANSCEIVER
11A TRANSMITTER
11B RECEIVER
12 IMAGING UNIT
13, 23 VALUE EXTRACTION UNITS
14, 34 SUBSET SELECTION UNITS
15 TRANSFORMATION UNIT
16 DETECTION UNIT
20 EXTRACTION CONTROL UNIT
30 CHANNEL REDUCTION UNIT
100, 200, 300 OBJECT DETECTION APPARATUS
110 OBJECT DETECTION SYSTEM
111 TRANSMISSION ANTENNA
112 RECEPTION ANTENNA
113 DISPLAY UNIT
1000 SYSTEM CONFIGURATION
1001 SERVER
1002 COMPUTER
1002A CPU
1002B MEMORY
1002C INPUT/OUTPUT INTERFACE (I/O)
1002D BUS
1011 TRANSMISSION ANTENNA
1012 RECEPTION ANTENNA
1101 TRANSCEIVER
1102 IMAGING UNIT
1103 VALUE EXTRACTION UNIT
1105 TRANSFORMATION UNIT
1106 DETECTION UNIT
1107 DISPLAY UNIT
1200 RADAR-BASED BODY SCANNER SYSTEM
1201 TARGET PERSON
1202 FIXED AREA
1203 SIDE PANEL

What is claimed is:

1. An object detection apparatus comprising:
a receiver configured to receive a radio wave transmitted to a target and scattered by the target to acquire a signal;
an imaging unit configured to generate a 3D complex image of the target based on the signal;
a value extraction unit configured to extract intensity information and phase information for each point of the 3D complex image to generate a value set including the an intensity matrix and a phase matrix, the extracted intensity information constituting the intensity matrix and the extracted phases information constituting the phase matrix;
a subset selection block configured to select a subset from the value set;
a transformation unit configured to change a representation of the subset to generate a 2D real image; and
a detection unit configured to detect whether there is an undesired object on the target based on the 2D real image.

2. The detection apparatus according to claim 1, wherein
the value extraction unit extracts an intensity value and a phase value for each point of the 3D complex image; or
the value extraction unit extracts a real value and an imaginary value for each point of the 3D complex image to calculate the intensity value and the phase value.

3. The detection apparatus according to claim 1, further comprising an extraction control unit configured to the control the value extraction unit to extract the phase matrix and the intensity matrix each dimension of which is reduced compared to the 3D complex image.

4. The detection apparatus according to claim 3, wherein the extraction control unit controls the value extraction unit to extract a part of the intensity information and the phase information in the 3D complex image.

5. The detection apparatus according to claim 4, wherein the value extraction unit selects one or more depth of the 3D complex image whose intensity information and phase information to be extracted, and extracts the intensity information and the phase information from the selected depth of the 3D complex image.

6. The detection apparatus according to claim 5, wherein the value extraction unit generates a depth matrix indicating the points to be selected and adds the depth matrix into the value set.

7. The detection apparatus according to claim 6, further comprising a channel reduction unit reduces the content of the subset.

8. The detection apparatus according to claim 7, wherein, when one of the phase information and the intensity information of each point is less than a predetermined value, the channel reduction unit replace the depth value, and the other of the phase information and the intensity information of each point.

9. The detection apparatus according to claim 8, wherein the predetermined value is zero.

10. The detection apparatus according to claim 1, further comprising a transmitter configured to transmit the radio wave to the target.

11. A data conversion unit comprising:
a value extraction unit configured to extract intensity information and phase information for each point of a 3D complex image to generate a value set including the an intensity matrix and a phase matrix, the 3D complex image being based on a signal acquired by receiving a radio wave transmitted to a target and scattered by the target, the extracted intensity information constituting the intensity matrix and the extracted phases information constituting the phase matrix;
a subset selection block configured to select a subset from the value set; and
a transformation unit configured to change a representation of the subset to generate a 2D real image.

12. An object detection system comprising:
a transmission antenna;
a reception antenna;
a transmitter configured to transmit a radio wave to the target through the transmission antenna;
a receiver configured to receive the radio wave scattered by the target through the reception antenna to acquire a signal;
an imaging unit configured to generate a 3D complex image of a target based on the signal;
a value extraction unit configured to extract intensity information and phase information for each point of the 3D complex image to generate a value set including the an intensity matrix and a phase matrix, the extracted intensity information constituting the intensity matrix and the extracted phases information constituting the phase matrix;
a subset selection block configured to select a subset from the value set;
a transformation unit configured to change a representation of the subset to generate a 2D real image;
a detection unit configured to detect whether there is an undesired object on the target based on the 2D real image and outputs the detection result; and
a display unit configured to display the detection result.

13-14. (canceled)
